(19) United States
(12) Patent Application Publication
(10) Pub. No.: US 2026/0171568 A1
(43) Pub. Date: Jun. 18, 2026

(54) AUXILIARY BATTERY

(71) Applicant: AMOGREENTECH CO., LTD., Gimpo-si, Gyeonggi-do (KR)

(72) Inventor: Seung-Yun RHO, Gimpo-si, Gyeonggi-do (KR)

(73) Assignee: AMOGREENTECH CO., LTD., Gimpo-si, Gyeonggi-do (KR)

(21) Appl. No.: 19/123,723

(22) PCT Filed: Oct. 19, 2023
(86) PCT No.: PCT/KR2023/016263

§ 371 Date: Apr. 23, 2025

(30) Foreign Application Priority Data
Oct. 24, 2022 (KR) 10-2022-0137785

(51) Int. Cl. H01M 50/238; H01M 10/48; H01M 50/105; H01M 50/136; H01M 50/202; H01M 50/227; H01M 50/24; H01M 50/247; H01M 50/262; H01M 50/284

(52) U.S. Cl. CPC H01M 50/238; H01M 10/488; H01M 50/105; H01M 50/136; H01M 50/202; H01M 50/227; H01M 50/24; H01M 50/247; H01M 50/262; H01M 50/284; H01M 2220/30

(57) ABSTRACT

An auxiliary battery is provided. An auxiliary battery, according to one embodiment of the present invention, comprises: a main body comprising a case, a circuit board built into the case, and charge and discharge ports mounted on the circuit board; and a battery unit which comprises a plate-shaped flexible battery having a predetermined area and a soft cover member covering the flexible battery, and is coupled to the main body such that the flexible battery is electrically connected to the circuit board, wherein the cover member may be formed of a flexible and waterproof material.

### CROSS-REFERENCE TO RELATED APPLICATIONS

This application is a 35 U.S.C. § 371 National Stage of International Patent Application No. PCT/KR2023/016263, filed Oct. 19, 2023, claiming benefit from Korean Patent Application No. 10-2022-0137785, filed Oct. 24, 2022, the disclosures of which are incorporated herein in their entirety by reference, and priority is claimed to each of the foregoing.

### TECHNICAL FIELD

The present invention relates to an auxiliary battery.

### BACKGROUND

Rescue workers, such as firefighters, perform activities to quickly and safely rescue people in emergency situations such as fires, disasters and disasters.

During these lifesaving activities, rescuers use various electronic devices such as cameras and headlights to ensure a smooth rescue.

However, since these rescue activities are carried out with rescuers carrying or wearing various electronic devices, if rescue activities take a long time, the electronic devices may not be supplied with sufficient driving power only from their own built-in batteries.

Accordingly, there is a need for a method that can operate electronic devices smoothly even if rescue operations take a long time.

### SUMMARY OF THE INVENTION

The present invention has been devised in consideration of the above points, and an object of the present invention is to provide an auxiliary battery that can supply a sufficient amount of driving power to portable or wearable electronic devices.

Another object of the present invention is to provide an auxiliary battery that can operate stably by preventing moisture infiltration.

In order to solve the above-described problems, provided is an auxiliary battery, including a main body including a case, a circuit board built into the case, and charge and discharge ports mounted on the circuit board; and a battery unit that includes a plate-shaped flexible battery having a predetermined area and a soft cover member covering the flexible battery, and is coupled to the main body such that the flexible battery is electrically connected to the circuit board, wherein the cover member may be formed of a flexible and waterproof material.

In addition, the cover member may be formed of a silicone material.

In addition, the flexible battery may be provided symmetrically on both sides of the circuit board.

In addition, the case may include an upper case that covers an upper surface of the circuit board, and a lower case that covers a lower surface of the circuit board and is fastened to the upper case, and the battery unit may be fixed to the case at one end by coupling the upper case and the lower case.

In addition, the battery unit may include a coupling groove that is formed to be recessed to a certain depth along a peripheral surface of the cover member at one end side, the upper case may include a first protrusion that is formed by protruding from a surface facing the lower case to a certain height and inserted into the coupling groove, and the lower case may include a second protrusion that is formed by protruding from a surface facing the upper case to a certain height and inserted into the coupling groove.

In addition, the battery unit may include a first edge part and a second edge part that are formed along the longitudinal direction, and the first edge part may be formed to have a longer length than the second edge part.

In addition, the main body may further include an indicator for indicating a charge level of the flexible battery or indicating an on/off status.

In addition, the flexible battery may include a plate-shaped electrode assembly having a predetermined area; an exterior material configured to cover the electrode assembly; a first pattern formed on the electrode assembly such that peaks and valleys are repeatedly arranged along the longitudinal direction of the electrode assembly; and a second pattern formed on the exterior material such that peaks and valleys are repeatedly arranged along the longitudinal direction of the exterior material, wherein the first pattern and second pattern may be arranged such that the peaks and valleys match each other.

According to the present invention, it is possible to supply a sufficient amount of driving power to a portable or wearable electronic device using power provided from a flexible battery, thereby enabling the electronic device to be used for a long period of time.

In addition, the present invention adopts a waterproof structure to prevent moisture from penetrating, thereby stably providing driving power even in harsh environments such as rainy weather.

### BRIEF DESCRIPTION OF THE DRAWINGS

FIG. 1 is a diagram showing an auxiliary battery according to an embodiment of the present invention;

FIG. 2 is an exploded view of FIG. 1;

FIG. 3 is a diagram schematically showing the connection relationship between a battery unit and a circuit board in the auxiliary battery according to an embodiment of the present invention;

FIG. 4 is a diagram showing a state in which the main body and the battery are separated from an auxiliary battery according to an embodiment of the present invention;

FIG. 5 is a view of FIG. 4 from below;

FIG. 6 is a diagram showing an auxiliary battery according to another embodiment of the present invention, with the case and circuit board separated;

FIG. 7 is a diagram showing a flexible battery that can be applied to an auxiliary battery according to an embodiment of the present invention;

FIG. 8 is a separation diagram of FIG. 7; and

FIG. 9 is a usage status diagram of an auxiliary battery according to an embodiment of the present invention.

### DETAILED DESCRIPTION

Hereinafter, with reference to the attached drawings, embodiments of the present invention will be described in detail so that those skilled in the art can easily practice the present invention. The present invention may be implemented in many different forms and is not limited to the embodiments described herein. In order to clearly explain the present invention in the drawings, parts that are not related to the description are omitted, and identical or similar components are assigned the same reference numerals throughout the specification.

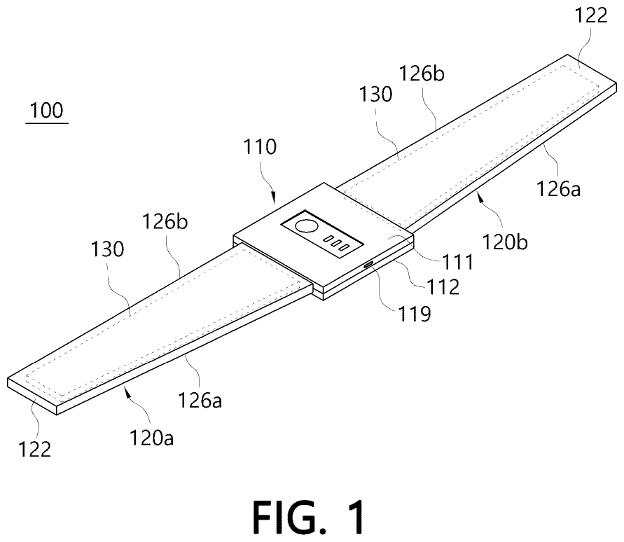

As shown in FIG. 1, the auxiliary battery 100 according to an embodiment of the present invention may include a main body 110 and battery units 120a, 120b.

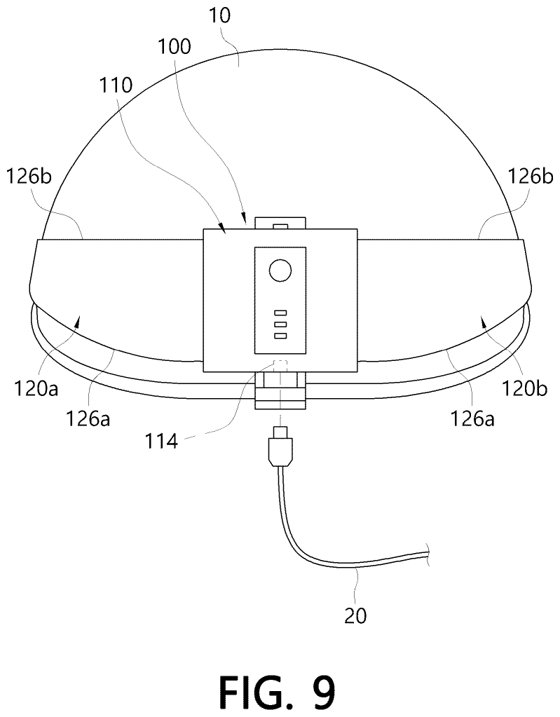

As shown in FIG. 9, the auxiliary battery 100 according to an embodiment of the present invention may be mounted on a helmet 10, such as a safety helmet, and it may supply power to external electronic devices while being mounted on the helmet 10.

That is, the auxiliary battery 100 according to an embodiment of the present invention may provide power to an external electronic device while being mounted on the user's body, clothing or accessory items.

In this case, the auxiliary battery 100 according to an embodiment of the present invention may be directly fixed to the user's body, clothing or accessory item, or may be fixed through a separate fixing member.

Accordingly, the user may use an external electronic device for a long period of time using the power provided from the auxiliary battery 100 according to an embodiment of the present invention.

Herein, the external electronic device may be an electronic device that the user can carry, such as a camera, a headlight and the like.

The main body 110 may fix one end of the battery units 120a, 120b that provide power. Such a main body 110 serves to fix the battery units 120a, 120b and may control the overall operation of the auxiliary batteries 100, 200 according to an embodiment of the present invention.

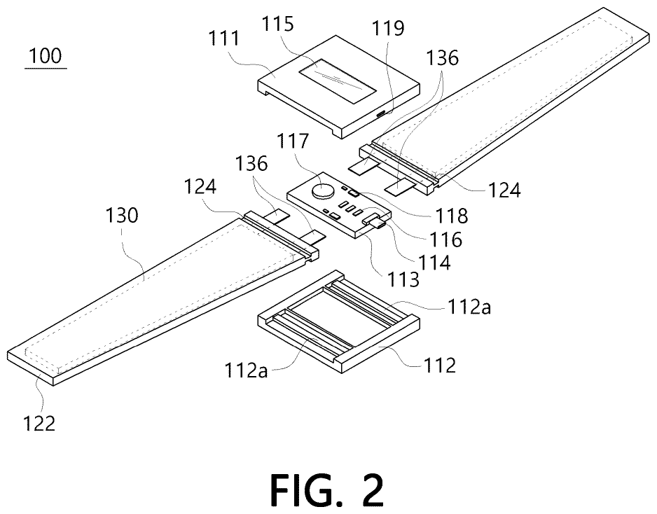

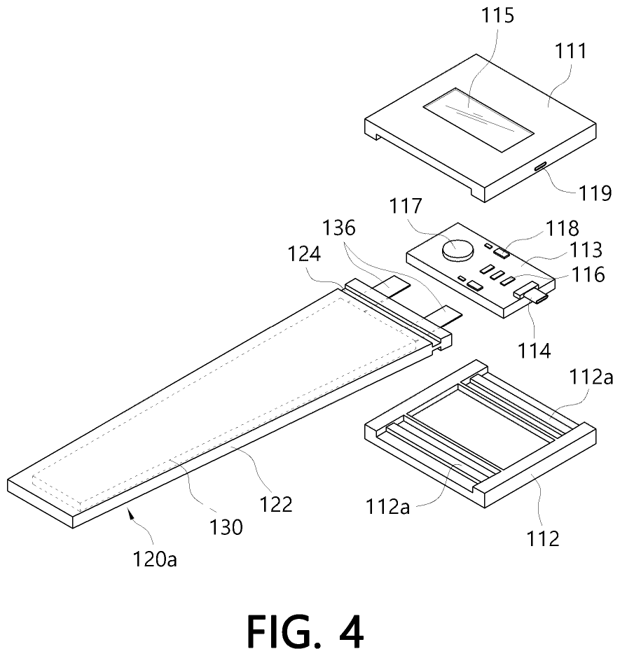

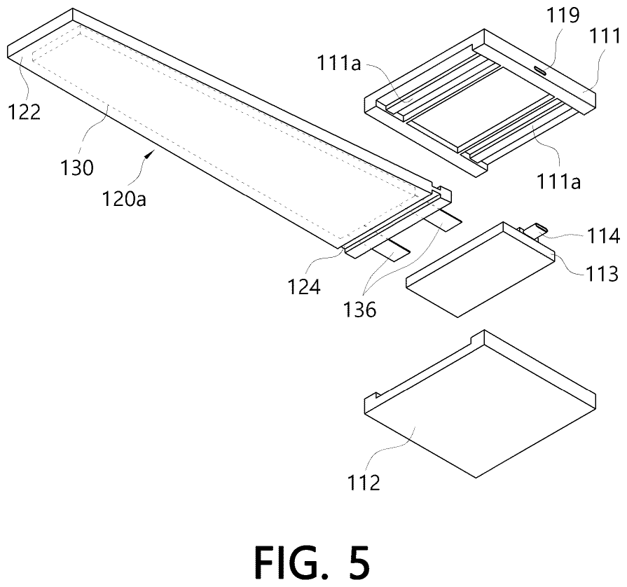

To this end, the main body 110 may include cases 111, 112, a circuit board 113, and charge and discharge ports 114, as shown in FIGS. 2 to 5.

The cases 111, 112 may include an upper case 111 that covers an upper surface of the circuit board 113, and a lower case 112 that covers a lower surface of the circuit board 113 and is fastened to the upper case 111.

In this case, the circuit board 113 may be embedded between the upper case 111 and the lower case 112 that are fastened to each other, and the charge and discharge ports 114 may be mounted on one surface of the circuit board 113.

Herein, the charge and discharge ports 114 may be provided in the main body 110 to be exposed to the outside while being mounted on the circuit board 113. For example, the charge and discharge ports 114 may be exposed to the outside through an opening hole 119 formed on one side of the upper case 111.

In addition, the circuit board 113 may be electrically connected to the battery units 120a, 120b, and a charging and discharging circuit (not shown) and a protection circuit (not shown) may be provided on the circuit board 113 side.

Moreover, the main body 110 may include a driving chip 118 that is mounted on one surface of the circuit board 113 to control overall driving.

Accordingly, when a known charging cable 20 is connected to the charging and discharging ports 114, the auxiliary battery 100 according to an embodiment of the present invention may supply power provided from the outside to the battery units 120a, 120b or supply power provided from the battery units 120a, 120b to an external electronic device.

Through this, the auxiliary battery 100 according to an embodiment of the present invention may charge the power of the battery units 120a, 120b using power supplied from the outside, or use power provided from the battery units 120a, 120b to charge the battery of an external electronic device.

In this case, the main body 110 may further include an indicator 116 for displaying a charge amount of the battery units 120a, 120b or indicating an on/off status. For example, the indicator 116 may be one or more LEDs that are mounted on one surface of the circuit board 113.

Moreover, the main body 110 may further include a separate switch 117 for turning on/off the auxiliary battery 100 according to an embodiment of the present invention, and the switch 117 may be mounted on one surface of the circuit board 113.

In this case, the upper case 111 may further include a transparent window 115 provided at a position corresponding to the indicator 116 and the switch 117.

Accordingly, the user may easily identify the charge amount and on/off status of the battery units 120a, 120b through the transparent window 115.

The battery units 120a, 120b may include a plate-shaped flexible battery 130 having a predetermined area and a soft cover member 122 covering the flexible battery 130.

Such battery units 120a, 120b may serve as a power supply source to provide driving power to external electronic devices.

To this end, the battery units 120a, 120b may be coupled to one side of the main body 110 such that the flexible battery 130 is electrically connected to the circuit board 113.

For example, the flexible battery 130 may be electrically connected to the circuit board 113 through an electrode terminal 136 that is exposed to the outside from an exterior material 135.

In this case, the cover member 122 may be made of a material that is flexible and waterproof. For example, the cover member 122 may be made of a flexible and waterproof silicone material.

In this case, the flexible battery 130 may be formed integrally with the cover member 122 through silicone molding, and the flexible battery 130 may be integrated with the cover member 122 such that the electrode terminal 136 extends a certain length to the outside of the cover member 122. That is, the remaining portion of the flexible battery 130 except for the electrode terminal 136 may be surrounded by the cover member 122 for electrical connection with the circuit board 113.

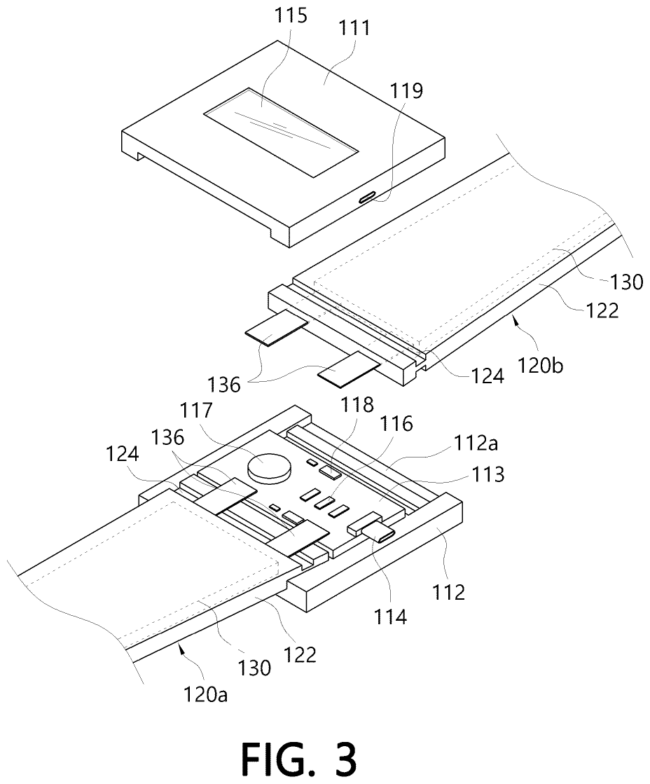

Accordingly, the battery units 120a, 120b may have flexibility similar to the flexible battery 130, and as shown in FIG. 3, the flexible battery 130 may be electrically connected to the circuit board 113 through the electrode terminal 136 provided so as to be exposed to a certain length outside the cover member 122 while being embedded in the cover member 122.

In this case, the flexible battery 130 may be provided as one, or may be provided on both sides of the main body 110. For example, the battery units 120a, 120b may be provided symmetrically on both sides of the main body 110.

Accordingly, since the auxiliary battery 100 according to an embodiment of the present invention has a pair of battery units 120a, 120b that are symmetrically provided on both sides of the main body 110, the storage capacity may be further increased.

Moreover, in the auxiliary battery 100 according to an embodiment of the present invention, the main body 110 may serve as the center of gravity of a pair of battery units 120a, 120b that are provided symmetrically on both sides, respectively, and thus, even if the storage capacity of the battery units 120a, 120b increases, they may be stably mounted on the user's body, clothing or accessory items.

In this case, in the auxiliary battery 100 according to an embodiment of the present invention, the cases 111, 112 may serve to protect the circuit board 113 that is embedded inside from the outside and also fix ends of the battery units 120a, 120b.

That is, the end sides of the battery units 120a, 120b may be fixed to the cases 111, 112 by coupling the upper case 111 and the lower case 112.

To this end, the battery units 120a, 120b may include a coupling groove 124 that is formed to be recessed to a certain depth along the peripheral surface of the cover member 122 at one end side, and the cases 111, 112 may include protrusions 111a, 112a corresponding to the coupling groove 124.

That is, the upper case 111 may include a first protrusion 111a that is formed by protruding at a certain height from a surface facing the lower case 112 and is inserted into the coupling groove 124, and the lower case 112 may include a second protrusion 112a that is formed by protruding at a certain height from a surface facing the upper case 111 and is inserted into the coupling groove 124.

Accordingly, while the electrode terminal 136 of the flexible battery 130 is fixed to the circuit board 113, when the upper case 111 and the lower case 112 are fastened to cover the upper and lower surfaces of the circuit board 113, the first protrusion 111a and the second protrusion 112a may be respectively inserted into the coupling groove 124, and the battery units 120a, 120b may be fixed to one side of the main body 110 while the flexible battery 130 is connected to the circuit board 113.

Through this, the electrode terminal 136 of the flexible battery 130 may be prevented from being exposed to the outside through the upper case 111 and the lower case 112, and the battery units 120a, 120b may have only the cover member 122 exposed to the outside while the electrode terminal 136 is covered by the cases 111, 112.

As a result, the auxiliary battery 100 according to an embodiment of the present invention may easily connect the main body 110 and the battery units 120a, 120b, and even if the battery units 120a, 120b are connected to one side of the main body 110, it is possible to secure waterproofing.

Herein, the first protrusion 111a, the second protrusion 112a and the coupling groove 124 serve as fastening members for interconnecting the battery units 120a, 120b and the cases 111, 112, and may also serve to block the path of moisture moving along a surface of the cover member 122.

That is, when moisture moves into the inside of the cases 111, 112 along the surface of the cover member 122, the movement path of moisture moving along the surface of the above cover member 122 may be blocked through a mutual coupling of the first protrusion 111a, the second protrusion 112a and the coupling groove 124.

For this reason, the auxiliary battery 100 according to an embodiment of the present invention may secure more excellent waterproofing properties by blocking moisture from moving from the outside to the inside of the cases 111, 112 through the mutual coupling of the first protrusion 111a, the second protrusion 112a and the coupling groove 124.

In the drawings, the first protrusion 111a is shown as protruding from an inner surface of the upper case 111, but the present invention is not limited thereto, and the first protrusion 111a may be provided to protrude a certain height from an edge of the upper case 111.

Similarly, the second protrusion 112a is shown as protruding from an inner surface of the lower case 112, but the present invention is not limited thereto, and the second protrusion 112a may be provided to protrude a certain height from an edge of the lower case 112.

Meanwhile, in the above description, the pair of battery units 120a, 120b are respectively shown as being individually provided and fastened to both sides of the main body 110, but the present invention is not limited thereto, and the pair of battery units 120a, 120b may be formed integrally.

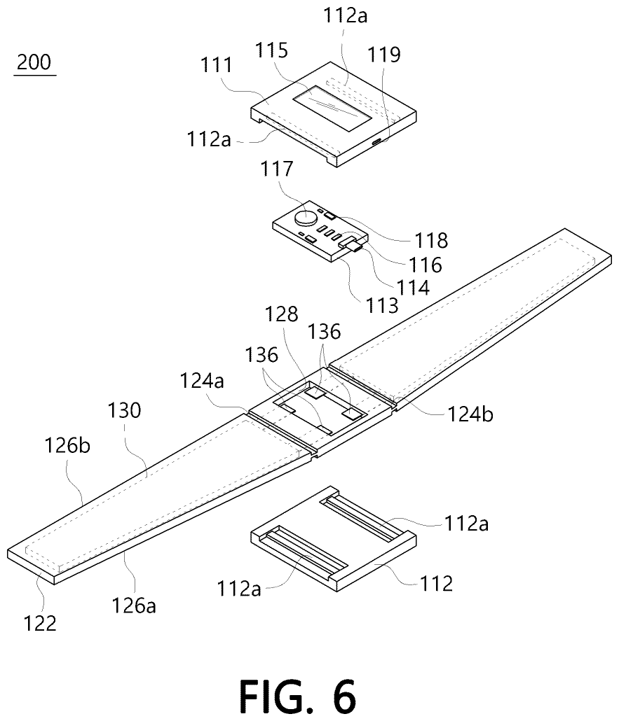

For example, as shown in FIG. 6, the auxiliary battery 200 according to an embodiment of the present invention may include two flexible batteries 130 that are disposed on both sides of the circuit board 113, and the remaining portions of the two flexible batteries 130, except for the electrode terminal 136, may be covered with one cover member 122.

That is, the auxiliary battery 200 according to the present embodiment may include a main body 110 and a battery unit 120, and unlike the above-described embodiment, the battery unit 120 may be provided with two flexible batteries 130 that are symmetrically positioned on both sides of the main body 110.

In this case, the main body 110 may be adopted as is in the above-described embodiment, and the circuit board 113 may be disposed on one surface of the cover member 122 so as to be positioned between the two flexible batteries 130, and the circuit board 113 may be disposed in a seating groove 128 formed on one surface of the cover member 122.

In addition, while each flexible battery 130 is respectively disposed on both sides of the circuit board 113, each electrode terminal 136 that is exposed to the outside of the cover member 122 may be connected to the circuit board 113 that is disposed in the seating groove 128.

That is, in the present embodiment, the two flexible batteries 130 may be covered around the remaining portion of the circuit board 113 except for one surface of the circuit board 113 through silicone molding while each electrode terminal 136 is connected to the circuit board 113, and one surface of the circuit board 113 that is exposed to the outside may be prevented from being exposed to the outside through the mutual coupling of the upper case 111 and the lower case 112.

Herein, the cover member 122 may include a pair of coupling grooves 124a, 124b that are formed to be recessed to a certain depth along the peripheral surface, and the upper case 111 may include a first protrusion 111a that is formed by protruding a certain height from a surface facing the lower case 112 and inserted into each of the pair of coupling grooves 124a, 124b, and the lower case 112 may include a second protrusion 112a that is formed by protruding a certain height from a surface facing the upper case 111 and inserted into each of the pair of coupling grooves 124a, 124b.

Accordingly, in the upper case 111 and the lower case 112, the first protrusion 111a and the second protrusion 112a may be respectively inserted into the pair of coupling grooves 124a, 124b formed in the cover member 122, and the circuit board 113 may be prevented from being exposed to the outside through the upper case 111 and the lower case 112 while being disposed on one surface of the cover member 122 so as to be positioned between the two flexible batteries 130.

Meanwhile, the battery units 120, 120a, 120b may be configured so as to be stably mounted on the user's body, clothing or accessory items while increasing the total storage capacity.

For example, the battery units 120, 120a, 120b may include a first edge part 126a and a second edge part 126b that are formed along the longitudinal direction, and the first edge part 126a may be formed to have a relatively longer length than the second edge part 126b.

Accordingly, as shown in FIG. 9, when the auxiliary batteries 100, 200 according to an embodiment of the present invention are mounted to surround the periphery of an article formed in a hemispherical shape, such as a helmet 10, if the first edge part 126a having a relatively longer length in the battery units 120, 120a, 120b is disposed to surround a relatively larger peripheral portion and the second edge part 126b having a relatively shorter length is disposed to surround a relatively smaller peripheral portion, the battery units 120, 120a, 120b may be stably mounted to the periphery of the article formed in a hemispherical shape.

In this case, if the flexible battery 130 that is built in the cover member 122 of the battery units 120, 120a, 120b is also formed to have a similar shape to the cover member 122, the flexible battery 130 may be provided to have a wider area.

As a result, the storage capacity of the flexible battery 130 may be increased.

Meanwhile, the flexible battery 130 that is built in the cover member 122 may be formed in a plate shape having a predetermined length and a predetermined area so as to have a high storage capacity while reducing the overall weight.

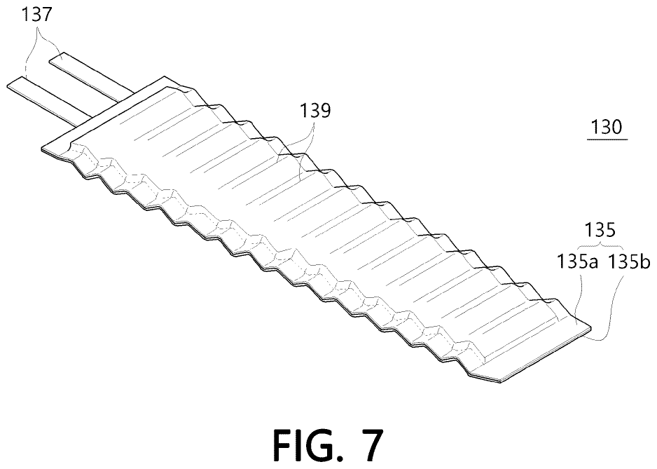

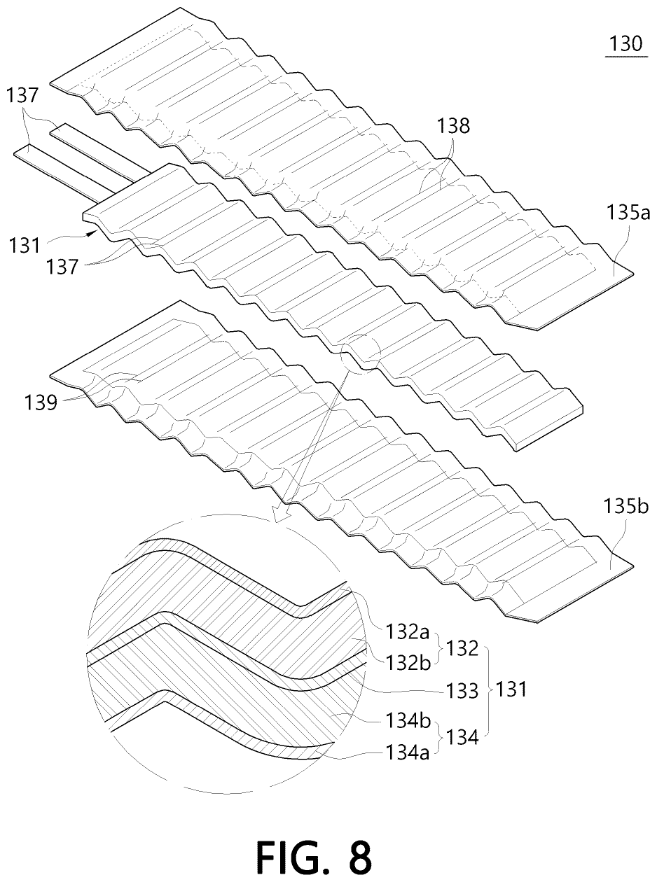

For example, as shown in FIGS. 7 and 8, the flexible battery 130 may include an electrode assembly 131 and an exterior material 135, and the electrode assembly 131 and the exterior material 135 may be formed in a plate shape having a predetermined area.

In addition, the electrode assembly 131 may be sealed inside the exterior material 135 together with an electrolyte, and the flexible battery 130 may include a pair of electrode terminals 136 that are provided to be exposed from the electrode assembly 131 to the outside of the exterior material 135.

In this case, the pair of electrode terminals 136 may be electrically connected to the circuit board 113 by being exposed to the outside without being covered by the cover member 122 as described above.

In the present invention, as shown in FIG. 7, the electrode assembly 131 may include a positive electrode 132, a negative electrode 134 and a separator 133, and the positive electrode 132 may include a positive electrode current collector 132a and a positive electrode active material 132b, and the negative electrode 134 may include a negative electrode current collector 134a and a negative electrode active material 134b.

Moreover, the pair of electrode terminals 136 may be respectively formed to extend a certain length from the positive electrode current collector 132a and the negative electrode current collector 134a, and the separator 133 may be disposed to be positioned between the positive electrode 132 and the negative electrode 134.

Since the positive electrode 132, the negative electrode 134 and the separator 133 are well-known content, a detailed description thereof will be omitted, and general contents that are conventionally employed in batteries may all be applied thereto.

In this case, as shown in FIGS. 1 to 6, the flexible battery 130 may be formed in a flat plate shape, but as shown in FIGS. 7 and 8, it may further include patterns 137, 138 that are formed such that peaks and valleys are repeatedly arranged along the longitudinal direction.

Such patterns 137, 138 may prevent performance degradation of the flexible battery 130 and damage to the flexible battery 130 when the flexible battery 130 is bent.

To this end, as shown in FIG. 8, the patterns 137, 138 may include a first pattern 137 formed on the electrode assembly 131 and a second pattern 138 formed on the exterior material 135, and the first pattern 137 and the second pattern 138 may be arranged such that the peaks and valleys match each other.

That is, the first pattern 137 may be formed such that the peaks and valleys are repeatedly arranged along the longitudinal direction of the electrode assembly 131, and the second pattern 138 may be formed such that the peaks and valleys are repeatedly arranged along the longitudinal direction of the exterior material 135.

Moreover, the first pattern 137 and the second pattern 138 may be formed such that the peaks and valleys are positioned at the same position as each other.

Through this, even if the flexible battery 130 is returned to its original state after being bent or curved at a predetermined curvature, changes in length may be offset through the first pattern 137 and the second pattern 138 formed to match each other.

Accordingly, even if the flexible battery 130 is mounted in a bent state with a predetermined curvature or is repeatedly bent, the amount of deformation of the substrate itself that may occur locally at the bent portion may be minimized, and thus, the electrode assembly 131 and the exterior material 135 may be prevented from being locally damaged or having their performance deteriorated at the bent portion.

Although one embodiment of the present invention has been described above, the spirit of the present invention is not limited to the embodiment presented in the present specification, and those skilled in the art who understand the spirit of the present invention will be able to easily suggest other embodiments by modifying, changing, deleting or adding components within the scope of the same spirit, but this will also be considered to fall within the spirit of the present invention.

1. An auxiliary battery, comprising:
a main body comprising a case, a circuit board built into the case, and charge and discharge ports mounted on the circuit board; and
a battery unit that comprises a plate-shaped flexible battery having a predetermined area and a soft cover member covering the flexible battery, and is coupled to the main body such that the flexible battery is electrically connected to the circuit board,
wherein the cover member is formed of a flexible and waterproof material.

2. The auxiliary battery of claim 1, wherein the cover member is formed of a silicone material.

3. The auxiliary battery of claim 1, wherein the flexible battery is provided symmetrically on both sides of the circuit board.

4. The auxiliary battery of claim 1, wherein the case comprises an upper case that covers an upper surface of the circuit board, and a lower case that covers a lower surface of the circuit board and is fastened to the upper case, and
wherein the battery unit is fixed to the case at one end by coupling the upper case and the lower case.

5. The auxiliary battery of claim 4, wherein the battery unit comprises a coupling groove that is formed to be recessed to a certain depth along a peripheral surface of the cover member at one end side,
wherein the upper case comprises a first protrusion that is formed by protruding from a surface facing the lower case to a certain height and inserted into the coupling groove, and
wherein the lower case comprises a second protrusion that is formed by protruding from a surface facing the upper case to a certain height and inserted into the coupling groove.

6. The auxiliary battery of claim 1, wherein the battery unit comprises a first edge part and a second edge part that are formed along the longitudinal direction, and
wherein the first edge part is formed to have a longer length than the second edge part.

7. The auxiliary battery of claim 1, wherein the main body further comprises an indicator for indicating a charge level of the flexible battery or indicating an on/off status.

8. The auxiliary battery of claim 1, wherein the flexible battery comprises:
a plate-shaped electrode assembly having a predetermined area;
an exterior material configured to cover the electrode assembly;
a first pattern formed on the electrode assembly such that peaks and valleys are repeatedly arranged along the longitudinal direction of the electrode assembly; and
a second pattern formed on the exterior material such that peaks and valleys are repeatedly arranged along the longitudinal direction of the exterior material,
wherein the first pattern and second pattern are arranged such that the peaks and valleys match each other.
